(19) United States
(12) Patent Application Publication
(10) Pub. No.: US 2025/0304471 A1
(43) Pub. Date: Oct. 2, 2025

(54) BLENDING VALVE FOR WATER TREATMENT SYSTEM

(71) Applicant: PARAGON WATER SYSTEMS, INC., Tampa (FL)

(72) Inventors: Ryan PRINCE, Clearwater, FL (US); Harkirat SAHNI, Tampa, FL (US)

(21) Appl. No.: 18/621,789

(22) Filed: Mar. 29, 2024

(51) Int. Cl. C02F 1/42; C02F 1/00

(52) U.S. Cl. CPC C02F 1/42; C02F 1/001; C02F 2201/005; C02F 2201/006

(57) ABSTRACT

A water treatment system includes a manifold configured for receiving untreated tap water, a filter cartridge in fluid communication with the manifold for receiving water to be treated and passing the water through the filter cartridge, a cartridge outlet of the filter cartridge being in fluid communication with the manifold, a connector in fluid communication with the manifold; and a blending valve adjustably positioned in the connector and configured for blending the tap water with water from the cartridge outlet under manual operator control and forming a blended product, the blended product being passed to a system outlet.

### BACKGROUND

The present invention relates generally to water treatment systems for improving the taste and consistency of drinking water used for mixing beverages, particularly in commercial establishments, and more specifically to an improved water treatment system that addressed drawbacks of conventional systems.

It is common for restaurants and fast food establishments to be equipped with water treatment systems for formulating beverages to consistent standards. These beverages include but are not limited to soft drinks and coffee, and the goal is that patrons will be more apt to receive drinks that taste as expected, or meeting manufacturer standards, regardless of the taste or composition of the local water supply. Such commercial treatment systems include at least one and usually several filter cartridges that receive the local potable water and treat it further to remove sediments, minerals, chlorine, chloramines, lead, bacteria, scale and/or hardness, depending on the local water source and/or the manufacturer's requirements. In many such systems, cartridges are provided with different filter media that are each designed for removing designated contaminants.

An unanticipated side effect of such commercial water treatment systems is that the treated water becomes excessively filtered to the extent that the water loses taste, due to extensive removal of minerals. As such, there have been efforts to modify conventional treatment systems to create a blended product water, whereby a certain amount of minerals is reintroduced to the treatment system post filtering, so that the output product has improved taste but is still filtered.

It has been found that such blending attempts have provided mixed and/or inconsistent results as far as the tase of the product. It has also been found that such modified systems are relatively complicated and/or difficult to maintain. Many such systems require electrical power to operate automatic blending valves. Others require relatively complicated plumbing modifications to existing systems, which also need to be designed for ready maintenance by relatively unskilled staff.

Accordingly, there is a need for an improved water treatment system of the type used by commercial establishments that addresses the drawbacks identified above.

### SUMMARY

The above-listed need is met or exceeded by the present water treatment system which features a blending valve located between two stages of water filters. The present blending valve is preferably built-in to a conventional connector, preferably an “H”-fitting, and blends drinking water that passed through a first or sediment filter with water having passed through both the sediment filter and a second filter such as an ion exchange filter. In an alternate embodiment, the present blending valve is incorporated into a system using a single filter cartridge. In the second embodiment, the blending valve blends water passing through the filter with untreated tap water.

Adjustment of the present valve is easily accomplished by the operator manually rotating a threaded valve stem, which controls the amount of blending. A Total Dissolved Solids (TDS) meter is connected to the present system to monitor the TDS of the system treated water output. In operation, the TDS meter is monitored by the operator as the blending valve is adjusted to achieve a desired level of minerals in the product water. Thus, the operator can adjust the setting of the valve by watching the TDS meter and thus obtain a desired TDS level, or taste level of the product water.

The present valve is relatively simple in construction. Besides being built in to the existing connector housing, the valve does not require a power source besides that provided by the operator and is mainly a threaded stem with a relatively large diameter knob that is easily adjusted by an unskilled operator. Another feature of the present blending valve is an overmolded, linear thread seal that envelops a free end of the rotating valve stem. As such, the stem is prevented from leaking throughout the full range of travel of the stem within the “H”-housing.

More specifically, a water treatment system is provided, including a first filter cartridge connected to a system inlet configured for receiving water to be treated and passing the water through the first filter cartridge, a first cartridge outlet of the first filter cartridge being in fluid communication with a connector constructed and arranged for receiving water from the first cartridge outlet and feeding the water to a second cartridge inlet. A second filter cartridge is configured for receiving water from the second cartridge inlet; a second cartridge outlet of the second filter cartridge passing the water from the second filter cartridge to a system outlet; and a blending valve adjustably positioned in the connector and configured for receiving water from the first cartridge outlet and blending the water with water from the second cartridge outlet and forming a blended product, the blended product being passed to the system outlet.

In an embodiment, the first filter cartridge is a sediment filter. In an embodiment, the second filter cartridge is an ion exchange filter.

In an embodiment, the connector has a chamber configured for threadably and adjustably accommodating the blending valve. Preferably, the connector is an “H” fitting, and the chamber is located in a central passage of the “H” fitting. In an embodiment, the blending valve is a threaded stem, having an actuating knob at one end. Preferably, the stem further includes an overmolded seal on a free end of the stem opposite the actuating knob.

In a preferred embodiment, the overmolded seal extends from a tip of the stem at least a third of a length of the stem. In an embodiment, the tip is unthreaded and has a diameter that is smaller than a diameter of the stem adjacent the actuating knob. In another embodiment, a blending valve is provided that is configured for use in a water treatment system having a manifold, at least a first filter cartridge, and a connector connected to the manifold, the connector having a threaded chamber and in fluid communication with the first filter cartridge, the blending valve having: a threaded stem, having an actuating knob at one end and constructed and arranged for engaging the threaded chamber; and an overmolded seal on a free end of the stem opposite the actuating knob. In an embodiment, the overmolded seal extends from a tip of the stem at least a third of a length of the stem.

In an embodiment, adjustment of the threaded stem in the threaded chamber adjusts an amount of blending of a source of water with water dispensed from the at least one cartridge to create a blended product. The adjustment is preferably under manual operator control.

In still another embodiment a water treatment system includes a manifold configured for receiving untreated tap water, a filter cartridge in fluid communication with the manifold for receiving water to be treated and passing the water through the filter cartridge, a cartridge outlet of the filter cartridge being in fluid communication with the manifold, a connector in fluid communication with the manifold; and a blending valve adjustably positioned in the connector and configured for blending the tap water with water from the cartridge outlet under manual operator control and forming a blended product, the blended product being passed to a system outlet.

In an embodiment, the connector and the blending valve are mounted on one of an inlet side of the manifold and an outlet side of the manifold.

In an embodiment, the cartridge is one of a carbon filter cartridge and an ion exchange filter cartridge.

In an embodiment, the blending valve includes a threaded stem, having an actuating knob at one end; and an overmolded seal on a free end of said stem opposite said actuating knob, said overmolded seal extends from a tip of said stem at least a third of a length of said stem.

### BRIEF DESCRIPTION OF THE DRAWINGS

FIG. 1 is a top exploded view of the present water treatment system;

FIG. 2 is the perspective view of the present blending valve;

FIG. 3 is a vertical section of the valve;

FIG. 4 is a vertical cross-section of the connector showing the valve in a closed position;

FIG. 5 is a vertical cross-section of the connector showing the valve in a half-open position;

FIG. 6 is a vertical cross-section of the connector showing the valve in a fully open position;

FIG. 7 is a fragmentary horizontal cross-section showing the valve engaged in the passage;

FIG. 8 is a top exploded view of a first version of an alternate embodiment of the water treatment system of FIG. 1;

FIG. 9 is a top exploded view of a second version of the alternate embodiment of the water treatment system of FIG. 1; and

FIG. 10 is a graph of the performance of the present blending valve showing total hardness in ppm plotted against the number of turns of the valve in the connector passage.

### DETAILED DESCRIPTION

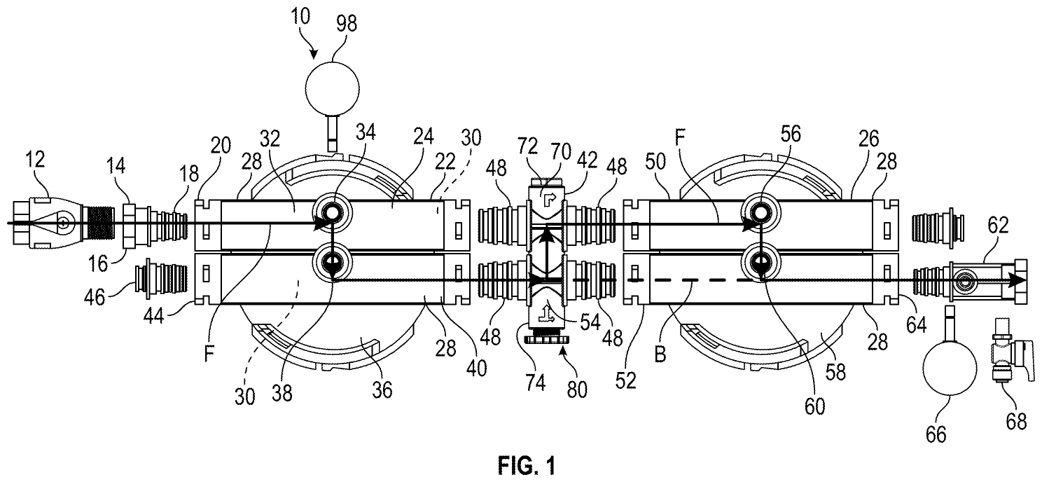

Referring now to FIG. 1, a water treatment system is generally designated 10, and is of the type conventionally installed in restaurants, fast food establishments and other commercial operations where beverages are dispensed. A main objective of the water treatment system 10 is to provide a consistency in the flavor of beverages sold by the restaurant, including, but not limited to coffee, tea, soft drinks and drinking water, regardless of the source of local potable water. Included in the system 10 is a system inlet 12 that is connected to a potable water supply through a conventional plumbing connection. The inlet 12 is threadably connected to an inlet fitting 14, having a first end 16 threadably receiving the inlet 12, and a second end 18 that is ribbed for being sealingly inserted into an end 20 of a tubular manifold 22.

In the present system 10, the tubular manifold 22 includes a first manifold member 24 and a second manifold member 26. While other configurations are contemplated, the manifold members 24, 26 each include a pair of parallel tubes 28 that are joined to each other, and define internal passages 30.

An inlet tube 32 of the first manifold member 24 is connected to a first cartridge inlet 34 of a first filter cartridge 36. In the preferred embodiment, the first cartridge 36 is a sediment filter, having internal filter media designed for removing sediments from the incoming potable water. Such media are well known in the art, and include mixtures of sands and other granular media. A first cartridge outlet 38 is connected to an outlet tube 40 of the first manifold member 24.

The outlet tube 40 is in fluid communication with a connector 42, in the preferred embodiment being a so-called “H” connector, however other equivalent connectors known in the art are contemplated. It should be noted that an open end 44 of the outlet tube 40 is provided with a sealed, ribbed press-on plug 46 for preventing unwanted leakage of water.

The connector 42 is provided with four tubular, ribbed legs or nipples 48 configured for press-on, sealed water flow connection with the inlet and outlet tubes 32, 40 of the first manifold member 24, and inlet and outlet tubes 50, 52 of the second manifold member 26. The nipples 48 are each in fluid communication with a preferably centrally-located internal passage 54 of the connector 42.

Referring now to the second manifold member 26, the inlet tube 50 is in fluid communication with a second cartridge inlet 56 of a second filter cartridge 58. In the preferred embodiment, the second filter cartridge 58 is an ion exchange cartridge, configured for more extreme or more complete filtration than the first filter cartridge 36. However, other types of cartridges are contemplated for the second filter cartridge 58 as are known in the art, including but not limited to carbon block, fiberglass fibers, Reverse Osmosis membrane, granular carbon and the like. The outlet tube 52 of the second manifold member 26 is in fluid communication with a second filter outlet 60 of the second filter cartridge 58.

A system outlet fitting 62 is connected to, and is in fluid communication with an outlet end 64 of the outlet tube 52. In the preferred embodiment, the system outlet fitting 62 is also ribbed for a tight, sealed friction fit in the tube 52. Preferably, a TDS meter 66 is connected to be in operational relationship to the outlet fitting 62 to measure the Total Dissolved Solids of product flowing through the outlet fitting. In addition, an optional shut-off valve 68 is connected to the outlet fitting 62.

Returning to the connector 42, the central internal passage 54 is oriented perpendicular to, and is in fluid communication with all four of the nipples 48. Also, the passage 54 has a first passage end 70 sealed off by a plug 72, functionally similar the sealed plug 46, but threadably engaging the passage 54. Opposite the first passage end 70, a second passage end 74 is internally threaded to threadably accept or accommodate the present blending valve, generally designated 80.

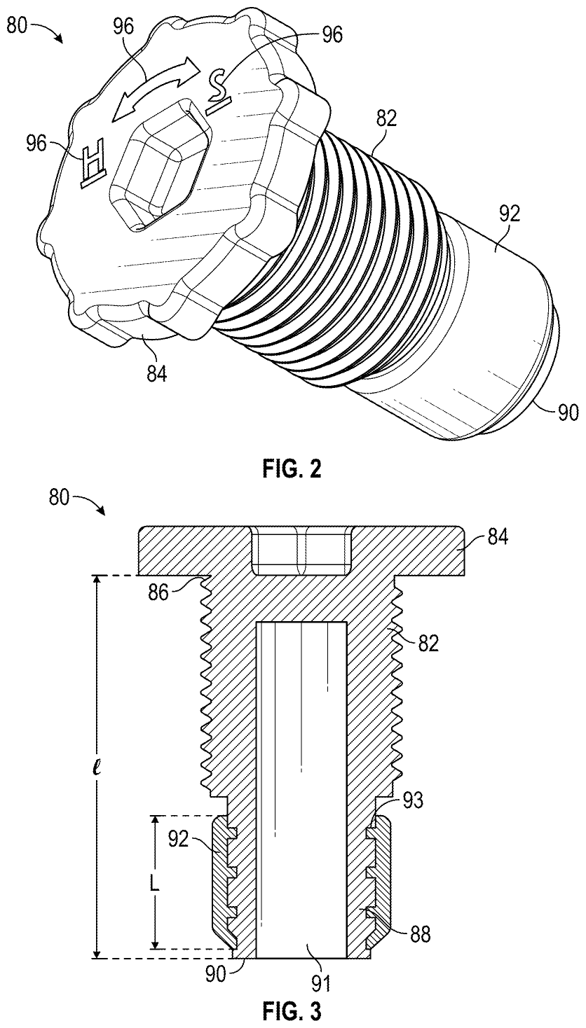

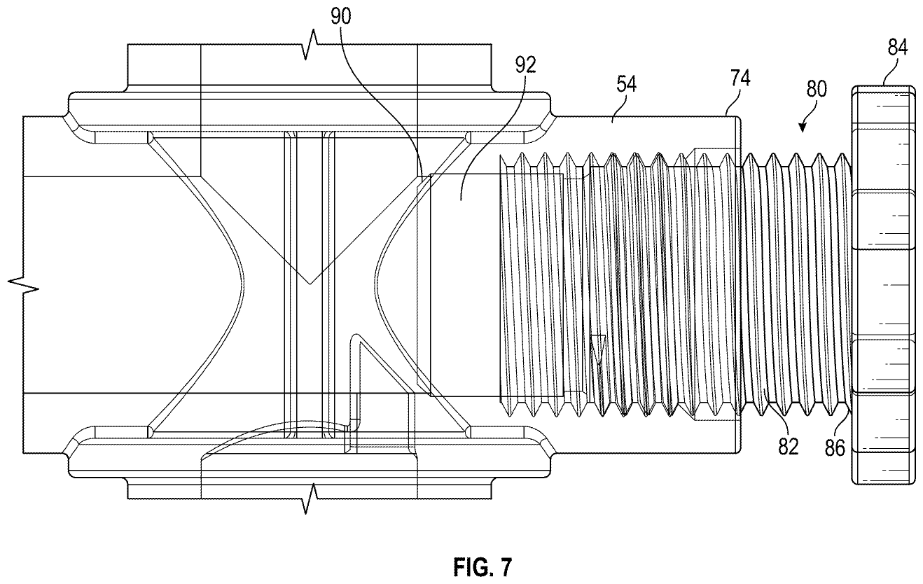

Referring now to FIGS. 2-7, the present blending valve 80 includes a threaded stem 82 having a relatively large diameter knob 84 at one stem end 86, and a tip 88 at an opposite or free stem end 90. The stem 82 is preferably hollow at 91. As seen in FIGS. 2 and 3, the tip 88 is unthreaded has a smaller diameter than the diameter of the stem end 86 adjacent the knob 84. In addition, the tip 88 is encapsulated by a seal 92 that is preferably overmolded over the tip so as to surround the tip. Also, the seal 92 has an axial length “L” that extends at least a third or 33% of an axial length “l” of the stem 82. The seal 92, once mounted to the stem 82 is constructed and arranged to control water flow within the passage 54. Preferably, the seal 92 is made of a resilient, water-resistant material that is conducive to overmolding and is chemically compatible with the material used to form the valve 80. In a preferred embodiment, the overmold seal 92 is a monoprene, and the substrate of the valve stem 82 is a glass filled 20% polypropylene. Other equivalent materials are contemplated as are known in the art. To enhance adhesion of the seal 92 to the tip 88, the tip is optionally provided with at least one annular groove 93 (FIG. 3).

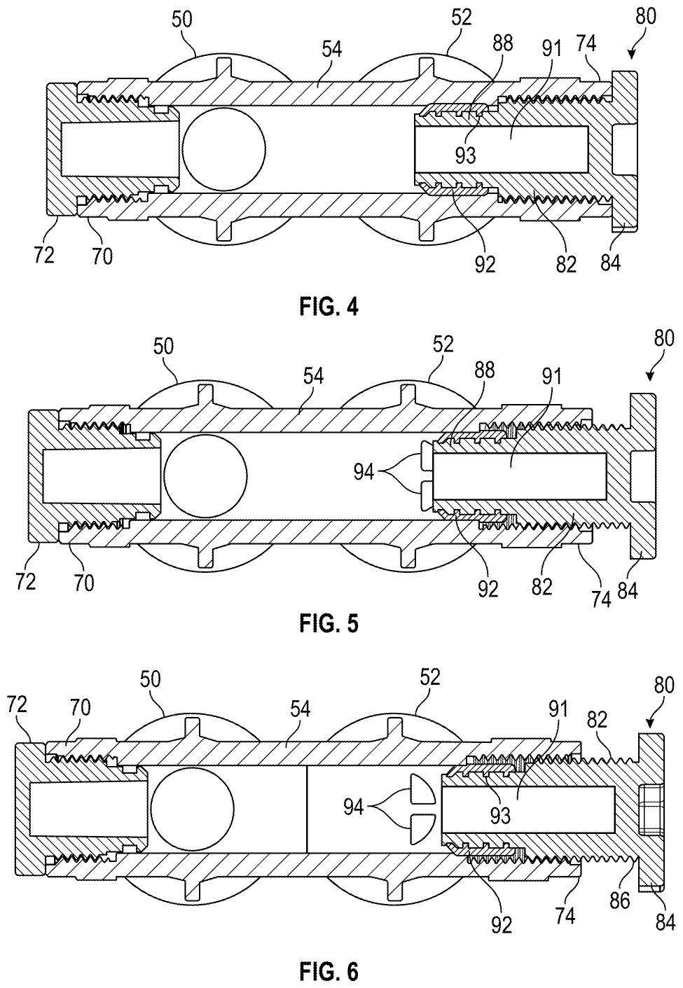

Referring now to FIGS. 4-6, an important feature of the present blending valve 80 is that the amount of extension or insertion of the valve 80 into the passage 54 determines the amount of blending of flow from the outlet 38 of the first cartridge 36, which has not been processed by the second filter cartridge 58, with flow from the second filter outlet 60. By this blending, minerals are added into the ultimate flow of the outlet fitting 62 to enhance the taste characteristics of the ultimate product water flow.

Referring now to FIG. 4, the blending valve 80 is fully threaded into the passage 54. As such, all of the flow from the first filter outlet 38 will be passed to the second cartridge inlet 56 for additional filtering, before being sent to the outlet fitting 62. In this position, there will be no blending of flows. This flow pattern is represented by the solid line F in FIG. 1.

Referring now to FIG. 5, the blending valve 80 is partially withdrawn or unscrewed from the passage 54, and as such the seal 92 has partially withdrawn from at least one blending aperture 94 in the passage. In the preferred embodiment, there are two blending apertures 94 each having a semi-triangular or pie piece-shaped configuration, however the number and configuration of the blending apertures may vary to suit the application. As seen in FIG. 1, the blending apertures 94 open up fluid communication from the passage 54 into the outlet tube 52 of the second manifold member 26. This flow pattern is designated by the dashed line “B” in FIG. 1. Accordingly, flow of filtered water from the first cartridge outlet 38 is then passed through the passage 54 into the outlet tube 52, where it is blended with the flow from the second filter outlet 60.

Referring now to FIG. 6, the blending valve 80 has been retracted or unscrewed to fully expose the blending apertures 94 so that an enhanced volume of water from the first filter cartridge outlet 38 is sent towards the system outlet fitting 62. In this position, a full amount of additional minerals is added to the system outlet flow at the fitting 62. In practice, the operator visually monitors the TDS meter 66 to determine the level of blending desired, with the more flow from the first cartridge outlet 38 being sent to the outlet fitting 62, the higher the TDS and the amount of taste-enhancing minerals.

Referring again to FIG. 2, the actuator knob 84 is optionally provided with indicia 96 including, but not limited to directional arrows representing rotational direction of the stem 82, “H” for hard or more minerals or higher ppm, and “S” for soft or reduced minerals or hardness/ppm. Also, referring to FIG. 1, an optional input TDS meter 98 is provided for monitoring the hardness or ppm of the incoming potable water.

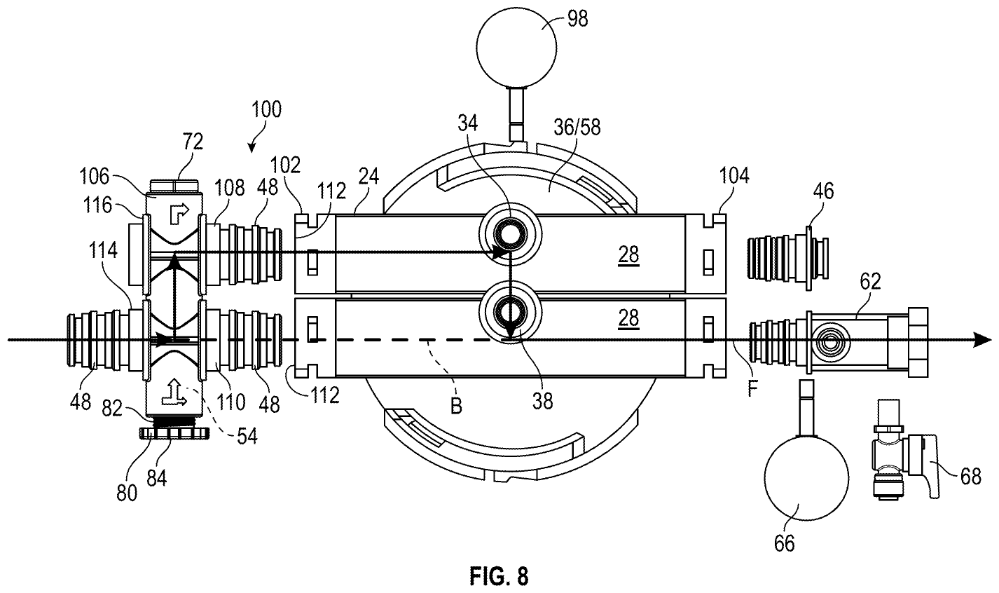

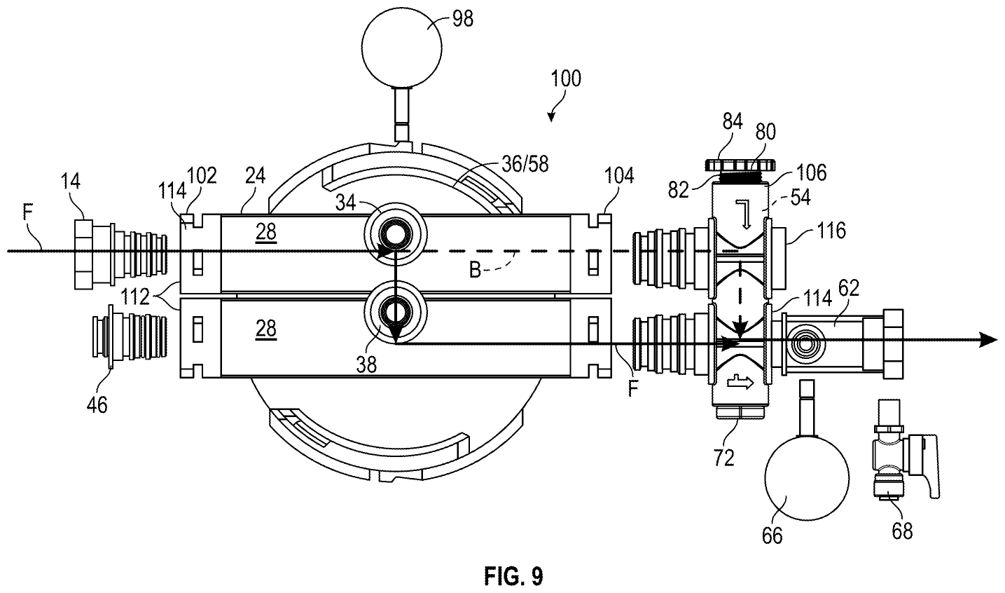

Referring now to FIGS. 8 and 9, an alternate embodiment of the present water treatment system is generally designated 100. Components shared with the system 10 are designated with identical reference numbers. A main distinction of the system 100 is that it employs only a single filter cartridge 36/58. The type of filter cartridge is contemplated as being variable, but preferably the filter cartridge is an ion exchange cartridge like the second filter cartridge 58, or another type of cartridge that removes a significant amount of minerals from the incoming water. In some cases, a carbon filter cartridge like the first filter cartridge 36 is considered suitable.

In the system 100 only the first manifold member 24 is employed, which includes the joined parallel tubes 28. In the system 100, the manifold member 24 has an inlet side 102 and an outlet side 104. In FIG. 8, at the inlet end 102, a modified connector 106 is provided. While the previous connector 42 was designated an “H” connector, the connector 106 is designated a “Y” connector, because there are only three ports. Two ports 108 and 110 are provided with ribbed nipples 48 and are tightly, insertably fitted into respective openings 112 in the tubes 28.

Another port 114 is placed in fluid communication with a source of water, such as tap water or other water to be treated. As shown, the port 114 has ribbed nipples 48 for receiving a push-on connection of a water supply conduit (not shown). However, other configurations, such as threaded or quick-connect connections are contemplated as are known in the art. The connector 106 is modified or integrally molded so that a fourth port 116 is blocked or plugged. As such, the connector 106 is either the same as the connector 42 with four nipples 48, one of which is plugged, or an alternate construction which is specifically manufactured with two nipples 48 at the ports 108 and 110 and the inlet port 114.

In the system 100, the blending valve 80, mounted in the connector 106, is positioned either on the inlet side 102 of the manifold 24 as seen in FIG. 8, or on the outlet side 104, of the manifold as seen in FIG. 9. When positioned on the inlet side 102, as influent water enters the connector 106 through the port 114, depending on the position of the valve stem 82 in the central passage 54, as is the case with the system 10, the amount of blending is achieved by the operator manually manipulating the knob 84 to achieve a desired amount of blending to achieve a target TDS value. Water from the inlet port 114 flows into the manifold member 24 and into the cartridge inlet 34. After treatment in the cartridge 36/58, the water flows from the cartridge outlet 38 into the manifold tube 28.

Depending on the position of the valve stem 82 in the central passage 54 of the connector, some flow of the incoming water entering the port 114 will be blended with the water treated by the cartridge 36/58 as shown by the dashed line “B”. As is the case with the system 10, an outlet fitting 62 is in fluid communication with the manifold tube 28, and a TDS meter 66 is installed to monitor the mineral content of the product water. A control valve 68 is also optionally provided. Also, in the manifold 24, the tube 28 adjacent the system outlet 62 is preferably provided with a sealed plug 46. Further the optional TDS meter 98 is also contemplated.

When the valve 80 is in the position indicated in FIG. 8, where the stem 82 is partially threaded into the connector 42, water flow “F” enters the inlet port 114, then flows through the central passage 54 into the cartridge inlet 34 via the respective tube 28. After being treated in the filter cartridge 36/58, the water then flows from the cartridge outlet 38, through the respective manifold tube 28 and through the system outlet fitting 62.

When additional minerals are desired in the treated water output, the operator then manipulates the knob 84 to unscrew or retract the valve stem 82 so that a desired amount of TDS is added, as reflected by the TDS meter 66.

Referring now to FIG. 9, the system 100 is shown with the connector 106 mounted on the outlet side 104 of the manifold member 24. It is contemplated that the positioning of the connector 106 as shown in FIGS. 8 and 9 is a matter of user preference, and in many cases relates to the space requirements of a particular installation. In FIG. 9, the system outlet 62 is connected to the port 114 in the connector 106. It will be seen that the connector 106 is inverted in FIG. 9 with respect to the orientation shown in FIG. 8. Despite these differences, the two versions of the system 100 shown in FIGS. 8 and 9 operate in the same manner.

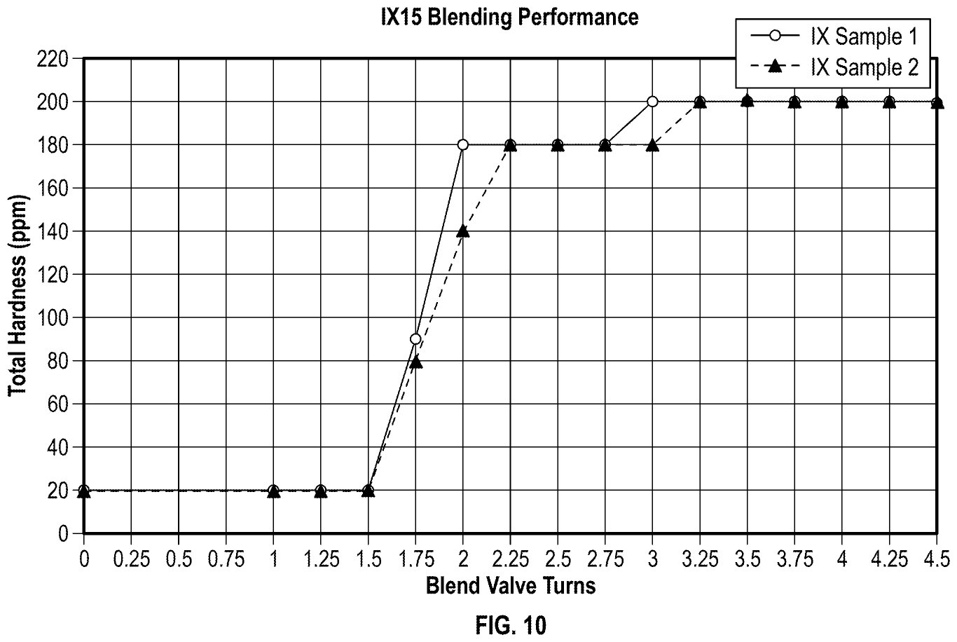

Referring now to FIG. 10, the effect of the blending valve 80 on the TDS of the flow from the system outlet fitting 62 is schematically indicated, by correlating blending valve turns on the “X” axis with Total Hardness in (ppm) on the “Y” axis. When viewed from left to right, the blending valve on the left edge of the graph is fully closed, as shown in FIG. 4. Then, the valve 80 is incrementally unscrewed or opened by ¼ turns. It will be seen that after 1.5 turns, the hardness begins to increase dramatically, between 1.5 and 2.0 full turns of the valve 80 in the passage 54, resulting in an increase in hardness from 20 ppm to 180 ppm. It has been found that at 20 ppm, there is an approximate 92% reduction in hardness or removal of minerals. At 200 ppm, there is a 20% reduction in minerals. This increase in hardness ppm is due to the blending apertures 94 being gradually exposed, as seen in FIG. 5. It will be appreciated that these values will vary with the threads per inch of the valve stem 82 and the diameter of the knob 84. Between 2.0 and 2.75 turns, the total hardness is fairly constant at about 180 ppm. However, at 3.0 turns the hardness increases to 200 ppm. This position is reflective of the position of the valve 80 in FIG. 6, and represents a maximum blending achieved by the present valve.

While a particular embodiment of the present blending valve for water treatment system has been described herein, it will be appreciated by those skilled in the art that changes and modifications may be made thereto without departing from the invention in its broader aspects and as set forth in the following claims.

1. A water treatment system, comprising:
a first filter cartridge connected to a system inlet configured for receiving water to be treated and passing the water through said first filter cartridge;
a first cartridge outlet of said first filter cartridge being in fluid communication with a connector constructed and arranged for receiving water from said first cartridge outlet and feeding the water to a second cartridge inlet;
a second filter cartridge configured for receiving water from said second cartridge inlet;
a second cartridge outlet of said second filter cartridge passing the water from said second filter cartridge to a system outlet; and
a blending valve adjustably positioned in said connector and configured for receiving water from said first cartridge outlet and blending the water with water from said second cartridge outlet and forming a blended product, said blended product being passed to said system outlet.

2. The water treatment system of claim 1, wherein said first filter cartridge is a sediment filter.

3. The water treatment system of claim 1, wherein said second filter cartridge is an ion exchange filter.

4. The water treatment system of claim 1, wherein said connector has a passage configured for threadably accommodating said blending valve.

5. The water treatment system of claim 4, wherein said connector is an “H” fitting including four legs each in fluid communication with said passage of the connector.

6. The water treatment system of claim 4, wherein said blending valve is a threaded stem, having an actuating knob at one end.

7. The water treatment system of claim 6, further including an overmolded seal on a tip of said stem opposite said actuating knob.

8. The water treatment system of claim 7, wherein said overmolded seal extends from a tip of said stem at least a third of a length of said stem.

9. The water treatment system of claim 7, wherein said tip is unthreaded and has a diameter that is smaller than a diameter of the stem adjacent said actuating knob.

10. The water treatment system of claim 1, further including a TDS meter disposed in operational relationship to said system outlet for monitoring a TDS value of the blended product.

11. A blending valve configured for use in a water treatment system having a manifold, at least a first filter cartridge, and a connector connected to the manifold, said connector having a threaded chamber and in fluid communication with the first filter cartridge, said blending valve comprising:
a threaded stem, having an actuating knob at one end and constructed and arranged for engaging said threaded chamber; and
an overmolded seal on a free end of said stem opposite said actuating knob.

12. The blending valve of claim 11, wherein adjustment of said threaded stem in said threaded chamber adjusts an amount of blending of a source of water with water dispensed from said at least one cartridge to create a blended product.

13. The blending valve of claim 11, wherein said connector is one of an “H” fitting, and a “Y” fitting, and said chamber is located in a central passage of one of said “H” fitting and said “Y” fitting.

14. The blending valve of claim 11, further including a TDS meter disposed in operational relationship to said system outlet for monitoring a TDS value of a blended product created by said blending valve.

15. The blending valve of claim 11, wherein said free end includes a tip that is unthreaded, and has a diameter smaller than a diameter of said stem adjacent said actuating knob.

16. A water treatment system, comprising:
a manifold configured for receiving untreated water;
a filter cartridge in fluid communication with said manifold for receiving water to be treated and passing the water through said filter cartridge;
a cartridge outlet of said filter cartridge being in fluid communication with said manifold;
a connector in fluid communication with said manifold; and
a blending valve adjustably positioned in said connector and configured for blending the water with water from said cartridge outlet under manual operator control and forming a blended product, said blended product being passed to a system outlet.

17. The water treatment system of claim 16, wherein said connector and said blending valve are mounted on an inlet side of said manifold.

18. The water treatment system of claim 16, wherein said connector and said blending valve are mounted on an outlet side of said manifold.

19. The water treatment system of claim 16, wherein said cartridge is one of a carbon filter cartridge and an ion exchange filter cartridge.

20. The water treatment system of claim 16, wherein said blending valve includes a threaded stem, having an actuating knob at one end; and
an overmolded seal on a free end of said stem opposite said actuating knob, said overmolded seal extends from a tip of said stem at least a third of a length of said stem.
